(19) United States
(12) Patent Application Publication
(10) Pub. No.: US 2026/0087608 A1
(43) Pub. Date: Mar. 26, 2026

(54) NOISE EVALUATION APPARATUS AND METHOD FOR MICROSCOPY APPARATUS

(71) Applicant: KOREA RESEARCH INSTITUTE OF STANDARDS AND SCIENCE, Daejeon (KR)

(72) Inventors: Takashi OGAWA, Daejeon (KR); Jun Hyeok HWANG, Icheon-si (KR)

(21) Appl. No.: 19/290,721

(22) Filed: Aug. 5, 2025

(30) Foreign Application Priority Data
Sep. 23, 2024 (KR) 10-2024-0128208
Jun. 12, 2025 (KR) 10-2025-0077057

(51) Int. Cl. G06T 7/00; G06T 5/10; G06T 5/20; G06T 5/70

(52) U.S. Cl. CPC G06T 7/0002; G06T 5/10; G06T 5/20; G06T 5/70; G06T 2207/10061; G06T 2207/20056

(57) ABSTRACT

An apparatus for evaluating noise effects acting on a microscopy apparatus, the apparatus comprising: a microscopy apparatus that detects signals generated from a sample to form corresponding detection signals; a noise sensor unit that detects noise to form corresponding noise detection signals, including a mechanical noise sensor that detects mechanical noise and a magnetic field sensor that detects magnetic field noise; a control unit that generates monitor signals corresponding to drive signals of the microscopy apparatus; and a signal processing unit that receives one or more of the noise detection signals and the monitor signals to perform signal processing, wherein the signal processing unit calculates correlations of one or more of the noise detection signals and the monitor signals on the detection signals.

### CROSS-REFERENCE TO RELATED APPLICATIONS

The present application claims priority to and the benefit of Korean Patent Application No. 10-2024-0128208, filed on Sep. 23, 2024 and Korean Patent Application No. 10-2025-0077057, filed on Jun. 12, 2025, which are all hereby incorporated by reference for in their entirety.

### BACKGROUND

Scanning microscopes position a probe at a specific location on a sample and detect signals. The probe is scanned two-dimensionally in X and Y directions on the sample, and signals are measured at each coordinate. Microscope images can be obtained by two-dimensional imaging of the signal amount at each coordinate as a gray level.

Among scanning microscopes, a microscope that uses an electron source as a beam source forms a probe by focusing an electron beam, and observes the sample surface using secondary electrons and backscattered electrons generated from the sample as signals is called a Scanning Electron Microscope (SEM). A microscope that uses transmits electrons through the thinly sliced samples, and observes the internal structures is called a Scanning Transmission Electron Microscope (STEM). SEMs and STEMs using electron beams are widely used in materials science, nanoscience, and electronics fields. Since microscopic observation by charged particle beam devices can achieve high spatial resolution, it is possible to observe structures that are too small to be observed with general optical microscopes, such as thin films grown on substrates, nanotubes, plasmonic structures, and atomic arrangements of samples. Additionally, charged particle beam devices can observe microstructures of biological samples such as cells and determine crystal structures of samples through electron diffraction images.

Scanning microscopes are devices for observing microstructures of samples. With advances in materials science, nanoscience, and electronics fields, demands for observing finer structures are increasing. However, when scanning microscopes are set to high magnification and samples are observed at greater magnification, resolution is often limited not only by the inherent resolution limits of the device due to probe dimensions but also by other factors. These limiting factors are called noise in microscope images. Such noise problems may occur after microscopes are installed at customer sites as products, and noise problems may also occur during research and development of new microscopes.

When acquiring microscope images of samples at high magnification with scanning microscopes, disturbances due to the environment where the microscope is installed may affect the microscope, or noise caused by disturbances may mix into signals detected by the microscope, affecting the microscope and preventing acquisition of good microscope images.

In scanning electron microscopes, multiple disturbance factors such as vibrations from the floor, noise, and magnetic fields have effects, making it difficult to identify causes. Since different countermeasures are required for the microscope depending on the type of noise, it was necessary to identify causes, and when disturbance noise mixes into microscope images after device installation, it is necessary to quickly identify causes and implement countermeasures.

In addition to the above-mentioned disturbances and noise, noise from control systems that supply multiple electrical signals (voltage or current) for operating microscopes may also have adverse effects. Therefore, it is necessary to identify causes including control systems in addition to disturbance noise and take measures.

### SUMMARY

According to one aspect, the present disclosure provides an apparatus for evaluating noise effects acting on a microscopy apparatus, the apparatus comprising: a microscopy apparatus that detects signals generated from a sample to form corresponding detection signals; a noise sensor unit that detects noise to form corresponding noise detection signals, including a mechanical noise sensor that detects mechanical noise and a magnetic field sensor that detects magnetic field noise; a control unit that generates monitor signals corresponding to drive signals of the microscopy apparatus; and a signal processing unit that receives one or more of the noise detection signals and the monitor signals to perform signal processing, wherein the signal processing unit calculates correlation of one or more of the noise detection signals and the monitor signals on the detection signals.

According to one aspect of the present embodiment, the microscopy apparatus is any one of: Scanning Electron Microscope (SEM), Scanning Transmission Electron Microscope (STEM), Scanning Ion Microscope (SIM), Focused Ion Beam (FIB), Helium Ion Microscope (HIM), Scanning Probe Microscope (SPM), Atomic Force Microscope (AFM), and Scanning Tunneling Microscope (STM).

According to one aspect of the present embodiment, the mechanical noise sensor includes one or more of: a vibration sensor that detects floor vibrations, a vibration sensor that detects vibrations of the microscopy apparatus, and an acoustic sensor that detects vibrations in the sound frequency band. In this aspect, the vibration sensor and the magnetic field sensor are three-axis sensors.

According to one aspect of the present embodiment, the microscopy apparatus includes one or more of a scanning unit, stigmator, alignment unit, lens unit, electron source, and high voltage source and current source for driving, the drive signals of the microscopy apparatus are drive signals of one or more of the scanning unit, stigmator, alignment unit, lens unit, electron source, and high voltage source and current source for driving, and the monitor signals are signals corresponding to the drive signals.

According to one aspect of the present embodiment, the microscopy apparatus further includes one or more of a secondary electron detector (SED), backscattered electron detector, transmitted electron detector, specimen absorption current detector, X-ray detector, and electron energy detector, and the detection signals further include signals formed by one or more of the secondary electron detector (SED), backscattered electron detector, transmitted electron detector, specimen absorption current detector, X-ray detector, and electron energy loss spectroscopy detector detecting the sample.

According to one aspect of the present embodiment, the signal processing unit calculates correlation coefficients of one or more of the noise detection signals and the monitor signals on the detection signals. In this aspect, the correlation coefficients calculated by the signal processing unit are one or more of Pearson correlation coefficient, Spearman correlation coefficient, and distance correlation coefficient.

According to one aspect of the present embodiment, the signal processing unit displays the noise, the monitor signals, and the detection signals in one or more of time domain, frequency domain by Welch method, and frequency domain.

According to one aspect of the present embodiment, the microscopy apparatus positions a probe at any point on the sample and detects signals with a detector, or positions and scans a probe along any edge of the sample and detects signals, or positions and scans a probe in a region including at least any portion of the sample and senses and detects signals to form detection signals.

According to one aspect of the present embodiment, the processing unit extracts signals within a set frequency band from one or more of the provided noise detection signals and monitor signals and the detection signals, and calculates correlations between the extracted signals and the detection signals.

According to one aspect of the present embodiment, the processing unit includes a preprocessing unit comprising: an FFT calculation unit that performs FFT operations on one or more of the input noise detection signals and monitor signals and the detection signals; a filter unit that extracts signals within a set band; and an IFFT calculation unit that performs IFFT (Inverse FFT) operations on output signals from the filter unit. In this aspect, the filter unit applies one or more of low-pass filter (LPF), band-pass filter (BPF), and high-pass filter (HPF) to one or more of the provided noise detection signals and monitor signals to extract signals within the set band.

According to one aspect of the present embodiment, the set band is a frequency band including frequency bands of noise affecting the microscope images.

According to another aspect, the present disclosure provides a method for evaluating noise effects acting on a microscopy apparatus, the method comprising: the microscopy apparatus detecting secondary electrons formed from the sample to form corresponding detection signals; noise sensors including mechanical noise sensors and magnetic field sensors detecting noise acting on the microscopy apparatus to form noise detection signals; generating monitor signals corresponding to drive signals of the microscopy apparatus; and a signal processing unit calculating correlations of one or more of the noise detection signals and monitor signals on the detection signals.

According to one aspect of the present embodiment, the microscopy apparatus is any one of: Scanning Electron Microscope (SEM), Scanning Transmission Electron Microscope (STEM), Scanning Ion Microscope (SIM), Focused Ion Beam (FIB), Helium Ion Microscope (HIM), Scanning Probe Microscope (SPM), Atomic Force Microscope (AFM), and Scanning Tunneling Microscope (STM).

According to one aspect of the present embodiment, the mechanical noise sensor includes a vibration sensor that detects floor vibrations, a vibration sensor that detects vibrations of the microscopy apparatus, and an acoustic sensor that detects vibrations in the sound frequency band. According to this aspect, the vibration sensor and the magnetic field sensor are three-axis sensors.

According to one aspect of the present embodiment, the microscopy apparatus includes one or more of a scanning unit, astigmatism correction unit, alignment unit, lens unit, electron source, and high voltage source and current source for driving, the drive signals of the microscopy apparatus are drive signals of one or more of the scanning unit, astigmatism correction unit, alignment unit, lens unit, electron source, and high voltage source and current source for driving, and the monitor signals are signals corresponding to the drive signals.

According to one aspect of the present embodiment, the microscopy apparatus further includes one or more of a secondary electron detector (SED), backscattered electron detector, transmitted electron detector, specimen absorption current detector, X-ray detector, and electron energy loss spectroscopy detector, and the detection signals further include signals formed by one or more of the secondary electron detector (SED), backscattered electron detector, transmitted electron detector, specimen absorption current detector, X-ray detector, and electron energy loss spectroscopy detector detecting the sample.

According to one aspect of the present embodiment, the signal processing unit calculates correlation coefficients of one or more of the noise detection signals and monitor signals on the detection signals. In this aspect, the correlation coefficients calculated by the signal processing unit are one or more of Pearson correlation coefficient, Spearman correlation coefficient, and distance correlation coefficient.

According to one aspect of the present embodiment, the signal processing unit displays the noise, the monitor signals, and the detection signals in one or more of time domain, frequency domain by Welch method, and frequency domain.

According to one aspect of the present embodiment, the microscopy apparatus positions a probe at any point on the sample and detects signals with a detector, or positions and scans a probe along any edge of the sample and detects signals, or positions and scans a probe in a region including at least any portion of the sample and senses and detects signals to form detection signals.

According to one aspect of the present embodiment, the method further includes a preprocessing step of extracting signals within a set frequency band from one or more of the 15 provided noise detection signals and monitor signals and the detection signals.

According to one aspect of the present embodiment, the preprocessing step includes a preprocessing unit comprising: an FFT calculation step that receives one or more of the noise detection signals and monitor signals and the detection signals and performs FFT operations; a filter step that extracts signals within a set band; and an IFFT calculation step that performs IFFT (Inverse FFT) operations on output signals from the filter unit. In this aspect, the filter step is performed by applying one or more of low-pass filter (LPF), band-pass filter (BPF), and high-pass filter (HPF) to one or more of the provided noise detection signals and monitor signals to extract signals within the set band.

According to one aspect of the present embodiment, the set band is a frequency band including frequency bands of noise affecting the microscope images.

### BRIEF DESCRIPTION OF THE DRAWINGS

FIG. 1 is a diagram showing an overview of an apparatus for evaluating noise effects acting on a microscopy apparatus of the present embodiment.

FIG. 2 is a flowchart schematically showing a method for evaluating noise effects acting on a microscopy apparatus of the present embodiment.

FIG. 3 and FIG. 4 are diagrams showing examples of the microscopy apparatus providing charged particle beams to a sample and detecting secondary electrons formed from the sample to understand noise effects.

FIG. 5 is a block diagram illustrating an overview of a preprocessing unit.

FIG. 6 is a flowchart illustrating an overview of a preprocessing method of the present embodiment.

FIG. 7A, FIG. 7B, and FIG. 7C are diagrams showing states where correlation coefficients are calculated and displayed to users.

FIG. 8A is a diagram showing input signals in the time domain, FIG. 8B is a diagram showing input signals in the frequency domain, and FIG. 8C is a diagram showing signals displayed in the frequency domain using the Welch method.

### DETAILED DESCRIPTION OF THE EMBODIMENTS

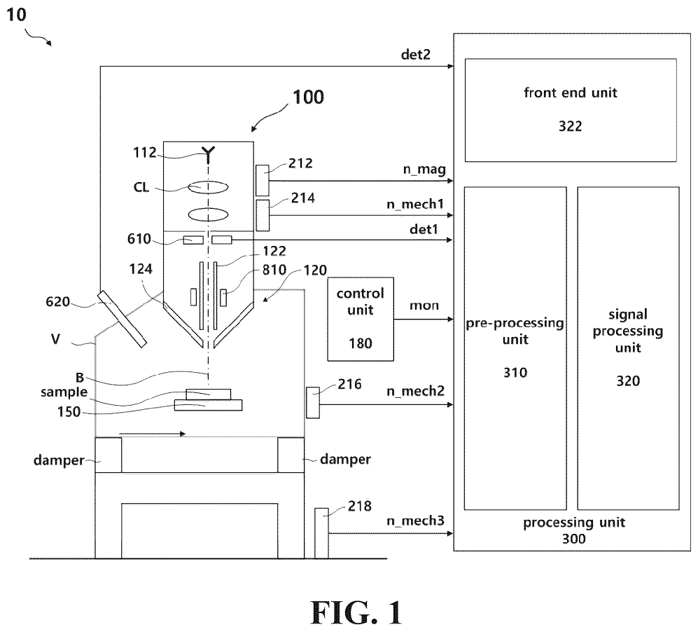

Hereinafter, the present embodiment will be described with reference to the accompanying drawings. FIG. 1 is a diagram showing an overview of an apparatus for evaluating noise effects acting on a microscopy apparatus of the present embodiment. Referring to FIG. 1, the noise effect evaluation apparatus 10 for a microscopy apparatus of the present embodiment includes: a microscopy apparatus 100 that detects signals generated from a sample to form corresponding detection signals; a noise sensor unit that detects noise to form corresponding noise detection signals, including mechanical noise sensors 214, 216, 218 and a magnetic field sensor 212; a control unit 180 that generates monitor signals mon corresponding to drive signals of the microscopy apparatus; and a signal processing unit 300 that receives one or more of the noise detection signals n_mech1, n_mech2, n_mech3, n_mag and monitor signals mon to perform signal processing, wherein the signal processing unit 300 calculates correlations of one or more of the noise detection signals n_mech1, n_mech2, n_mech3, n_mag and monitor signals mon on the detection signals det1.

In the illustrated embodiment, the microscopy apparatus 100 is a scanning electron microscope. However, the microscopy apparatus of the present embodiment is not limited thereto and may be a Scanning Transmission Electron Microscope (STEM) that detects signals transmitted through a sample and uses thin films as samples, a Scanning Ion Microscope (SIM) that uses an ion source as a light source, focuses an ion beam to form a probe, and uses secondary ions that detect secondary electrons generated from the sample, a Focused Ion Beam (FIB) apparatus that is a scanning ion microscope using liquid metal ion sources such as Ga as ion sources, or a Helium Ion Microscope (HIM) that is a scanning ion microscope using gas ion sources such as helium as ion sources.

Additionally, the microscopy apparatus of the present embodiment may be any one of a Scanning Probe Microscope (SPM) that uses a probe tip to detect interactions between the probe and sample and obtains microscope images by measuring probe displacement while controlling the distance between the probe and sample constant, an Atomic Force Microscope (AFM) that detects interatomic interactions and uses cantilevers, and a Scanning Tunneling Microscope (STM) that detects tunneling current. Hereinafter, for clear understanding of the present embodiment, a Scanning Electron Microscope (SEM) will be exemplified and described as the microscopy apparatus.

The microscopy apparatus 100 of the present embodiment includes a stage 150 on which a sample is placed, a charged particle source 112, a first detector 610 that detects secondary electrons formed from the sample and provides them as corresponding first detection signals det1, and an objective lens 120 that provides charged particle beams generated from the charged particle source 112 to the sample. The present embodiment may further include a control unit 180 that provides drive voltage and/or current to the microscopy apparatus 100 for operation.

The sample is positioned on the stage 150 located within a vacuum chamber (V). In one embodiment, the stage 150 is a five-axis stage, and the control unit 180 can control the stage 150 according to control commands provided by a user terminal to adjust the XYZ position, rotation, and tilt of the sample.

The microscopy apparatus 100 includes a charged particle source 112. In one embodiment, the charged particle source 112 includes a filament that is heated to emit electrons, a suppressor electrode that prevents charged particles from being emitted in arbitrary directions, an extractor electrode that extracts charged particles in desired directions and controls emission current, and an electron source pump that creates desired vacuum levels within the charged particle source.

In one embodiment, the microscopy apparatus 100 includes one or more condenser lenses CL. The charged particle beam B is focused by one or more condenser lenses CL and apertures, and the optical axis is aligned by multiple optical axis alignment units (not shown). Additionally, astigmatism correction of the charged particle beam B is performed by a stigmator (not shown).

The charged particle beam B proceeds to the objective lens 120 and is focused on the sample by the objective lens 120. In one embodiment, the objective lens 120 may be a magnetic field type, electrostatic type, or magnetic field/electric field compound type objective lens. In one embodiment where the objective lens 120 is electrostatic type, high voltage is supplied to an upper electrode 122 and a lower electrode 124 by the control unit 180. For example, the high voltage may be +1 to +30 kV.

In one embodiment where the objective lens 120 is electrostatic type, the objective lens 120 includes an upper electrode 122 and a lower electrode 124. In one embodiment, the microscopy apparatus 100 may further include a first detector 610 and a scanning unit 810 together with the objective lens 120. In embodiments not shown, the microscopy apparatus may include one or more of alignment units, lens units, electron sources, and high voltage sources and current sources for driving.

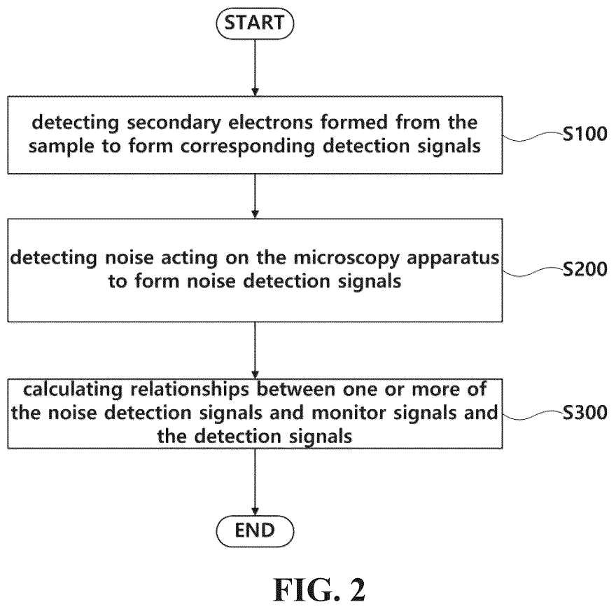

FIG. 2 is a flowchart schematically showing a method for evaluating noise effects acting on a microscopy apparatus of the present embodiment. Referring to FIGS. 1 and 2, the method for evaluating noise effects acting on a microscopy apparatus of the present embodiment includes: the microscopy apparatus 100 detecting secondary electrons formed from the sample to form corresponding detection signals (S100); noise sensors including mechanical noise sensors and magnetic field sensors detecting noise to form noise detection signals and the microscopy apparatus forming monitor signals corresponding to drive signals (S200); and a signal processing unit calculating correlations of one or more of the noise detection signals and monitor signals on the detection signals (S300).

In one embodiment, the apparatus 10 of the present embodiment can operate in a first operation mode for observing samples using the microscopy apparatus 100 and a second operation mode for evaluating noise effects acting on the microscopy apparatus 100, and users can select and operate either the first operation mode or the second operation mode when driving the apparatus 10 of the present embodiment. Hereinafter, the case where users operate the apparatus 10 of the present embodiment in the second operation mode will be described as an example.

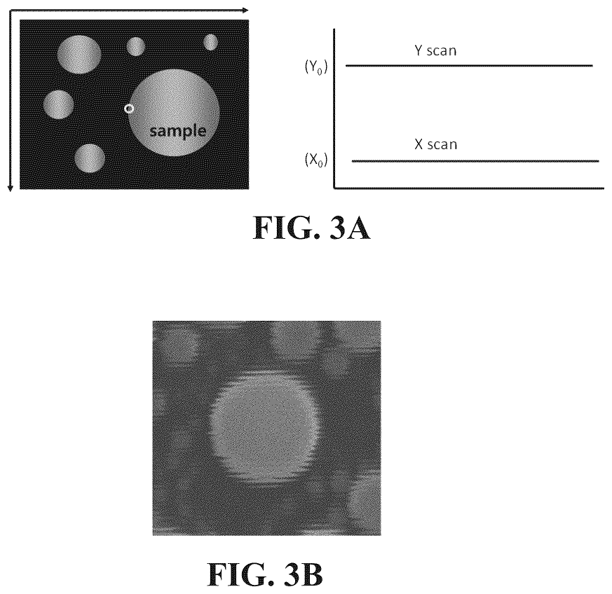

When the microscopy apparatus 100 provides charged particle beams to the sample, secondary electrons are formed from the sample. The first detector 610 detects secondary electrons and forms first detection signals det1 corresponding to the detected secondary electrons. FIG. 3 is a diagram showing examples of the microscopy apparatus 100 providing charged particle beams to samples and detecting secondary electrons formed from samples to understand noise effects. Referring to FIGS. 1 to 3A, the microscopy apparatus 100 may provide charged particle beams to the boundary of the sample and not move them. The scan signals provided in the x-axis direction and y-axis direction may both be DC signals. As shown in the example, static charged particle beams are provided to any point on the sample boundary, secondary electrons formed from the sample are detected, and corresponding detection signals are output.

FIG. 3B is a diagram exemplifying SEM microscope images based on detection signals when noise is involved when charged particle beams are provided to samples. As shown, it can be confirmed that noise involvement causes tearing phenomena where the sample periphery is torn or ripple phenomena where wave patterns are formed on the sample periphery.

Therefore, by fixing charged particle beams to any static part of the sample for irradiation and detecting secondary electrons therefrom, the effects of noise provided to the microscopy apparatus 100 on detection signals can be more easily understood.

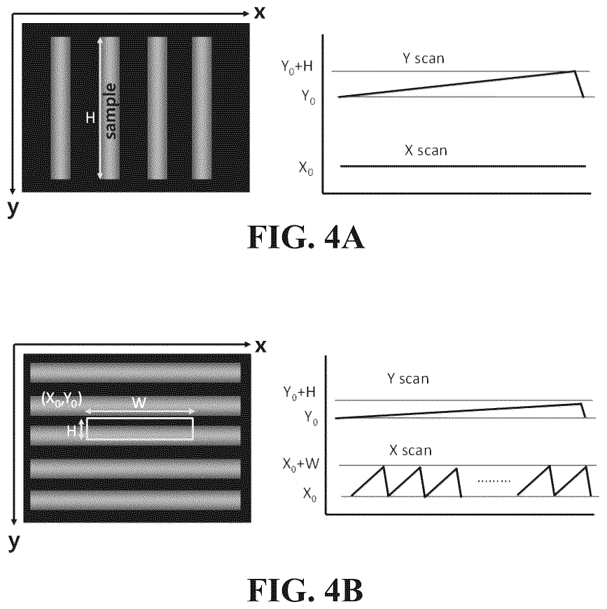

Referring to FIG. 4A, the microscopy apparatus 100 may provide charged particle beams along any edge of a sample with multiple rectangular patterns drawn and not move them. The scan signal in the x-axis direction may be a DC signal so that charged particle beams are provided at the same coordinates along the x-axis. Additionally, the scan signal in the y-axis direction may change so that charged particle beams provided along the y-axis move.

As shown in the example, by providing charged particle beams along sample boundaries and acquiring detection signals, the effects of noise provided to the microscopy apparatus 100 on detection signals can be more easily understood.

Referring to FIG. 4B, the microscopy apparatus 100 can acquire detection signals by moving charged particle beams to provide them over areas including the outer boundaries of samples with multiple rectangular patterns drawn. The scan signals in the x-axis and y-axis directions may be changing signals so that charged particle beams are provided within designated areas.

In one embodiment, the first detector 610 that provides first detection signals det1 may include a photomultiplier (PMT) that detects secondary electrons formed by charged particle beams B provided by the charged particle beam apparatus 100 and forms first detection signals det1 that are corresponding electrical signals.

The microscopy apparatus 100 may further include a second detector 620 that provides second detection signals det2. For example, the second detector 620 may be one or more of secondary electron detector (SED) including a photomultiplier (PMT), backscattered electron detector, transmitted electron detector, specimen absorption current detector, X-ray detector, and electron energy loss spectroscopy detector, and the second detection signals det2 may be signals formed by the above-mentioned second detector 620 detecting the sample or detecting signals formed from the sample.

Noise sensors including mechanical noise sensors 214, 216, 218 and magnetic field sensor 212 detect noise to form noise detection signals n_mech1, n_mech2, n_mech3, n_mag, and the microscopy apparatus forms monitor signals mon corresponding to drive signals (S200).

The apparatus 10 of the present embodiment may include mechanical noise sensors 214, 216, 218 and magnetic field sensor 212. In one embodiment, the mechanical noise sensor 214 is a sensor that detects vibrations in the acoustic frequency band. The mechanical noise sensor 214 detects vibrations in the acoustic frequency band and forms and outputs noise detection signals n_mech1 corresponding to the detected vibrations. For example, the mechanical noise sensor 214 may output signals through a single channel.

The mechanical noise sensor 216 detects vibrations of the microscopy apparatus 100 and forms and outputs noise detection signals n_mech2 corresponding to the detected vibrations. In one embodiment, the microscopy apparatus 100 is placed on a damper to attenuate vibrations transmitted from the floor S at the installed location. However, since dampers cannot completely attenuate vibrations, vibrations can be transmitted to the microscopy apparatus 100 through dampers even when placed on dampers. The mechanical noise sensor 216 of the present embodiment detects vibrations in x, y, z axes transmitted through dampers and provides noise detection signals n_mech2 corresponding to the detected vibrations through respective channels.

The mechanical noise sensor 218 detects vibrations transmitted from the floor S at the location where the microscopy apparatus 100 is installed and forms and outputs noise detection signals n_mech3 corresponding to the detected vibrations. The mechanical noise sensor 218 detects vibrations in x, y, z axes and provides noise detection signals n_mech3 corresponding to the detected vibrations through respective channels.

The magnetic field sensor 212 detects magnetic fields affecting the microscopy apparatus 100 and outputs noise detection signals n_mag corresponding to the detected magnetic fields through three channels: x, y, z.

The microscopy apparatus 100 of the present embodiment operates when high voltage sources and current sources provide electrical signals to, or receive electrical signals from the charged particle source 112, condenser lenses CL, stigmators (not shown) that perform astigmatism correction, objective lens 120, and scanning unit 810.

Additionally, the microscopy apparatus 100 includes a control unit 180, and the control unit 180 provides voltages and currents for driving the microscopy apparatus 100 to elements of the microscopy apparatus and receives necessary signals. Since voltages and currents provided through the control unit 180 can act as noise to the microscopy apparatus 100, the control unit 180 forms monitor signals mon corresponding to voltages, currents provided to the microscopy apparatus 100, and signals such as voltages and currents received from the microscopy apparatus and provides them to the processing unit 300.

In one embodiment, drive signals provided to the microscopy apparatus 100 may be one or more of scanning units, stigmators, alignment units, lens units, electron sources, and high voltage sources and current sources for driving, with voltages ranging from several volts to tens of kilovolts. The control unit 180 forms monitor signals mon that correspond to electrical signals but have adjusted output ranges and are standardized, and provides them to the processing unit 300. In one embodiment, the control unit 180 forms monitor signals mon with amplitudes corresponding to the input dynamic range of ADCs included in the processing unit 300 and provides them to the processing unit 300. In one embodiment, monitor signals mon may be standardized as signals with −10V to 10V amplitude or signals with −2.5V to 2.5V amplitude.

In the illustrated embodiment, the processing unit 300 may include a front end unit 322. In one embodiment, the front end unit 322 receives noise detection signals output by mechanical noise sensors 214, 216, 218 and magnetic field sensor 212 and monitor signals mon output by the control unit 180, and processes them so that the signal processing unit 320 can process them.

In one embodiment, the front end unit 322 may perform analog signal preprocessing such as impedance matching, buffering, and amplification for input analog signals, as well as output branching and output attenuation. Additionally, the front end unit 322 may perform signal sampling and analog-to-digital conversion using ADC (analog digital converter) for signals that have undergone analog signal preprocessing. In one embodiment, the sampling time (or frequency) of the front end unit 322 may vary depending on the scan time (or frequency) for acquiring scan microscope images that require noise measurement. For example, in the case of laboratory SEMs, since single images are acquired in 1 to 3 minutes, a sampling frequency of 500 Hz to 1 kHz is sufficient. In another example, high-performance microscopy apparatus may require faster sampling frequencies of 1 kHz or higher.

In one embodiment, the front end unit 322 may include signal acquisition devices including general-purpose measuring instruments such as data loggers and oscilloscopes, and may use dedicated ADCs.

In the example illustrated in FIG. 1, the front end unit 322 is illustrated as being included in the processing unit 300. However, in embodiments not shown, the front end unit 322 may be located separately from the processing unit and provide processed signals to the processing unit. The signal processing unit calculates correlations of the detection signals and the noise and drive signals from the noise on drive signals.

In one embodiment, the signal processing unit 320 may be a digital signal processing device (DSP) implemented with FPGA. In another embodiment, the signal processing unit 320 may be implemented as software written in programming languages on computers.

As described above, users can select and operate either the first operation mode or the second operation mode when driving the apparatus 10 of the present embodiment. In embodiments where users operate the apparatus 10 of the present embodiment in the first operation mode to observe samples with the microscopy apparatus 100, the first detection unit 610 including a photomultiplier (PMT) forms detection signals det1 that are electrical signals corresponding to secondary electrons formed when charged particle beams B are provided to samples. By this way, samples can be observed.

When users drive the apparatus 10 of the present embodiment in the second operation mode, first detection signals det1 provided by the first detection unit 610 are provided to the signal processing unit 300. Additionally, one or more of noise detection signals n_mech1 provided by mechanical noise sensor 214, noise detection signals n_mech2 provided by mechanical noise sensor 216, noise detection signals n_mech3 provided by mechanical noise sensor 218, noise detection signals n_mag provided by magnetic field sensor 212, and monitor signals mon provided by control unit 180 are provided to the signal processing unit 300. In one embodiment, mechanical noise sensors and/or magnetic field sensors that output noise detection signals through multiple channels may provide at least one channel of noise detection signals to the signal processing unit 300.

In one embodiment, when driving the apparatus 10 of the present embodiment in the second operation mode, second detection signals det2 provided by the second detection unit 620 may be further provided to the signal processing unit 300.

The signal processing unit 300 calculates correlations of one or more of noise detection signals n_mech1, n_mech2, n_mech3, n_mag provided by the noise sensor unit and monitor signals mon provided by the control unit 180 on first detection signals det1. In one embodiment, the signal processing unit 300 further calculates correlations of one or more of noise detection signals n_mech1, n_mech2, n_mech3, n_mag provided by the noise sensor unit and monitor signals mon provided by the control unit 180 on second detection signals det2 provided by the second detection unit 620.

Correlations of one or more of noise detection signals n_mech1, n_mech2, n_mech3, n_mag and monitor signals mon on detection signals can be obtained by calculating correlation coefficients. In one embodiment, calculation of correlations between detection signals and noise and/or drive signals may be performed by calculating Pearson correlation coefficients. Pearson correlation coefficients can be calculated as in Equation 1 below.

$${ρ}_{X , Y} = \frac{cov ( X , Y )}{{σ}_{X} {σ}_{Y}} \qquad [ Equation 1 ]$$

$$cov ( X , Y ) = E [ ( X - E [ X ] ) ( Y - E [ Y ] ) ]$$

$${σ}_{X} = \sqrt{E [ {X}^{2} ] - ( {E [ X ]}^{2} )}$$

In Equation 1, X and Y are variables corresponding to results measured by each sensor and detector. cov(X, Y) is covariance, and σ is standard deviation. Also, E[ ] is the expected value.

In another embodiment, calculation of correlations between detection signals and noise and/or drive signals may be performed by calculating Spearman correlation coefficients. Spearman correlation coefficients can be calculated as in Equation 2 below.

$${r}_{S} = {ρ}_{R ( X ) , R ( Y )} = \frac{cov ( ( R ( X ) , R ( Y ) )}{{σ}_{R ( X )} {σ}_{R ( Y )}} \qquad [ Equation 2 ]$$

In Equation 2, R( ) is a rank variable.

In another embodiment, calculation of correlations between detection signals and noise and/or drive signals may be performed by calculating distance correlation coefficients. Distance correlation coefficients can be calculated as in Equation 3 below.

$${dCov}_{n}^{2} ( X , Y ) = \frac{]}{{n}^{2}} {{\sum }_{j = 1}}^{n} {{\sum }_{k = 1}}^{n} ( {A}_{j , k} {B}_{j , k} ) \qquad [ Equation 3 ]$$

$${A}_{j , k} = {a}_{j , k} - \overline{{a}_{j .}} - \overline{{a}_{. k}} + \overline{{a}_{..}}$$

$${B}_{j , k} = {b}_{j , k} - \overline{{b}_{j .}} - \overline{{b}_{. k}} + \overline{{b}_{..}}$$

$${a}_{j , k} = ‖ {X}_{j} - {X}_{k} ‖ , j , k = 1 , 2 , … , n$$

$${b}_{j , k} = ‖ {Y}_{j} - {Y}_{k} ‖ , j , k = 1 , 2 , … , n$$

In Equation 3, a_{j·} is j-th row average, a_{·k} is k-th column average, a . . . is grand mean, and ∥ ∥ is Euclidean norm.

As described above, correlations of noise and/or drive signals involved in detection signals can be obtained by calculating Pearson correlation coefficients, Spearman correlation coefficients, and distance correlation coefficients. Correlations of noise and/or drive signals involved in detection signals may be calculated and displayed to users as one or more of Pearson correlation coefficients, Spearman correlation coefficients, and distance correlation coefficients according to user selection.

In another example, one of Pearson correlation coefficients, Spearman correlation coefficients, and distance correlation coefficients may be calculated and displayed to users according to the distribution of noise values and/or drive signal values. In one embodiment, Pearson correlation coefficients show relatively high relevance when noise and/or drive signals involved in detection signals are linear. Therefore, the signal processing unit 320 calculates Pearson correlation coefficients and informs users when involved noise and/or drive signals are linear.

In another embodiment, Spearman correlation coefficients show relatively high relevance when noise and/or drive signals involved in detection signals are nonlinear. Therefore, the signal processing unit 320 calculates Spearman correlation coefficients and informs users when involved noise and/or drive signals are nonlinear.

In another embodiment, distance correlation coefficients show relatively high relevance when noise and/or drive signals involved in detection signals are periodic. Therefore, the signal processing unit 320 calculates distance correlation coefficients and informs users when involved noise and/or drive signals are periodic.

However, while one of Pearson correlation coefficients, Spearman correlation coefficients, and distance correlation coefficients can be calculated and displayed to users, in other embodiments, one or more of Pearson correlation coefficients, Spearman correlation coefficients, and distance correlation coefficients can be calculated and displayed.

In one embodiment, the signal processing unit 320 can receive preprocessed signals and calculate correlations of noise and/or drive signals mon to display them as graphs to users. For example, the signal processing unit 320 can display noise and/or drive signals for each channel measured in the time domain according to user selection. In another example, the signal processing unit 320 can convert signals measured in the time domain to the frequency domain according to user selection to display noise and/or drive signals for each channel in the frequency domain. In another example, the signal processing unit 320 can convert signals measured in the time domain to the frequency domain according to user selection and convert and display noise and/or drive signals for each channel in the frequency domain according to the Welch algorithm.

In the above-described embodiment, calculated correlation coefficient values and/or calculated graphs can be displayed according to user selection. Therefore, users can identify which noise factors have the highest impact in order while simultaneously understanding noise effects by referring to correlations of noise and/or drive signals mon that are converted to the frequency domain and converted by Welch's method along with calculated correlation coefficient values.

Noise measured by apparatus 10 may include both noise having frequency components that have relatively large effects on image distortion and noise frequency having components that have relatively small effects on image distortion due to low signal strength. Therefore, when actually calculating correlation coefficients, correlation coefficients may be underestimated due to low-intensity frequency signals.

This problem occurs when low-intensity and high-intensity frequency signals are mixed, and underestimation of correlation coefficients due to low-intensity frequency signals can make it difficult to identify noise causes that have major effects on the microscopy apparatus 100.

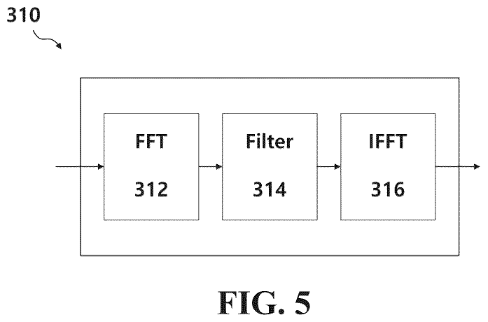

In one embodiment, the apparatus 10 may further include a pre-processing unit 310 that performs preprocessing processes for noise. FIG. 5 is a block diagram illustrating an overview of the preprocessing unit 310. Referring to FIG. 5, the preprocessing unit 310 includes an FFT calculation unit 312 that receives input signals and performs FFT, a filter unit 314 that extracts signals in a set band, and an inverse FFT unit 316 that performs inverse FFT (inverse FFT) operations on signals output by the filter unit 314.

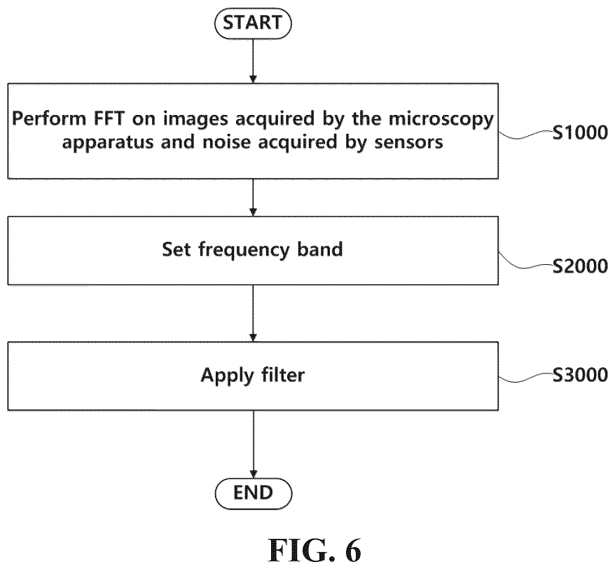

FIG. 6 is a flowchart illustrating an overview of a preprocessing method of the present embodiment. Referring to FIG. 6, the preprocessing method includes performing FFT (Fast Fourier Transform) on images acquired by the microscopy apparatus 100 and noise acquired by sensors S1000, setting frequency bands S2000, and applying filters S3000. In one embodiment, the preprocessing method may further include a step of inverse FFT (inverse FFT) converting signals to the time domain.

The preprocessing process will be described with reference to FIGS. 5 and 6. The FFT calculation unit 312 of the preprocessing unit 310 performs FFT on images acquired by the microscopy apparatus 100 and noise acquired by sensors (S1000). In one embodiment, signals input to the preprocessing unit 310 may be one or more of noise signals n_mag, n_mech1, n_mech2, n_mech3 output by noise sensors and monitor signals mon. In another embodiment, signals input to the preprocessing unit 310 may be signals output by the front end unit 322 after processing noise signals n_mag, n_mech1, n_mech2, n_mech3 output by noise sensors and monitor signals mon. Images acquired by the microscopy apparatus 100 may include not only image components but also various noise components. FFT is performed on images acquired by the microscopy apparatus 100. Since images are two-dimensional images, they can be converted to spatial frequency units. In one embodiment, spatial frequency may have reciprocal dimensions of length. For example, spatial frequency may have reciprocal dimensions of length such as 1/m, 1/(μm), 1/(nm).

To convert reciprocal dimensions of length to time frequency (Hz), the speed of electron beam scanning signals used to acquire images from the microscopy apparatus 100 is utilized. For example, when x-axis scanning speed is 1 μs/Pixel and y-axis scanning speed is 1 ms/Line, the time frequency ranges of images acquired by the microscopy apparatus that underwent FFT are ±500 kHz and ±500 Hz respectively. Therefore, by performing FFT on images acquired by the microscopy apparatus, noise frequencies affecting images can be compared and identified with data measured by sensors.

Additionally, noise components may include noise detection signals n_mech1 corresponding to noise components in the acoustic frequency band, noise detection signals n_mech2 that detect vibrations of the microscopy apparatus 100 transmitted through dampers, noise detection signals n_mech3 corresponding to vibrations detected and transmitted from the floor S where the microscopy apparatus 100 is installed, and noise detection signals n_mag corresponding to magnetic fields detected.

The FFT calculation unit 312 performs FFT on each of the noise signals n_mech1, n_mech2, n_mech3, n_mag detected by sensors, which may include components measured along x, y, and z axes. Therefore, by performing FFT on each noise, frequency bands of each noise signal can be identified. Furthermore, the FFT calculation unit 312 may perform FFT on monitor signals mon provided by the control unit 180 (S1000).

The filter unit 314 sets frequency bands (S2000). The set frequency bands may be frequency bands of noise affecting images acquired by the microscopy apparatus 100. In one embodiment, the set frequency bands may be set as cutoff frequencies, passband frequencies, etc. of the filter unit 314. For example, the set frequency bands may be frequency bands including multiple noise frequencies that have the major impact on images. In another example, the set frequency bands may be frequency bands including noises affecting images.

In one embodiment, filters may be included in the filter unit 314 to selectively output noise within set frequency bands. For example, if noise spectra include noise at 20 Hz and 40 Hz, noise affecting images acquired by the microscopy apparatus 100 is 20 Hz, and frequency bands that do not affect the apparatus or have little effect among noise signals n_mag, n_mech1, n_mech2, n_mech3 output by noise sensors are 40 Hz, the filter unit 314 blocks 40 Hz frequency noise and selectively outputs 20 Hz noise. This prevents underestimation of 20 Hz noise correlation coefficients and allows selective output of noise in frequency bands with greater impact.

In another example, if it can be known from noise spectra that noise is distributed in 30 Hz, 60 Hz, 90 Hz frequency bands, noise affecting images acquired by the microscopy apparatus 100 is 60 Hz, and 30 Hz and 90 Hz noises are frequency bands that do not affect the apparatus or have little effect, a band-pass filter (BPF) included in the filter unit 314 can be set to block 30 Hz and 90 Hz and selectively output signals in a certain range including 60 Hz. This prevents underestimation of 60 Hz noise correlation coefficients and prevents incorrect evaluation of correlation coefficients due to 30 Hz and 90 Hz noises that have little impact on the apparatus.

In another example, when noise affecting images acquired by the microscopy apparatus 100 is 100 Hz but signals at 50 Hz frequency are included in noise signals n_mag, n_mech1, n_mech2, n_mech3 output by noise sensors and correlation coefficients for 100 Hz noise may be underestimated, a high-pass filter (HPF) that blocks 50 Hz and selectively outputs signals in frequency ranges including 100 Hz can be set. Filters can selectively output noise within set frequency bands.

In one embodiment, after performing the filter application step (S3000), inverse FFT 316 may be performed on acquired noise signals. By performing inverse FFT, acquired noise signals can be converted to time domain signals, and from signals converted to the time domain, correlation coefficients with noise affecting images can be measured and evaluated more precisely and effectively.

### Experimental Results

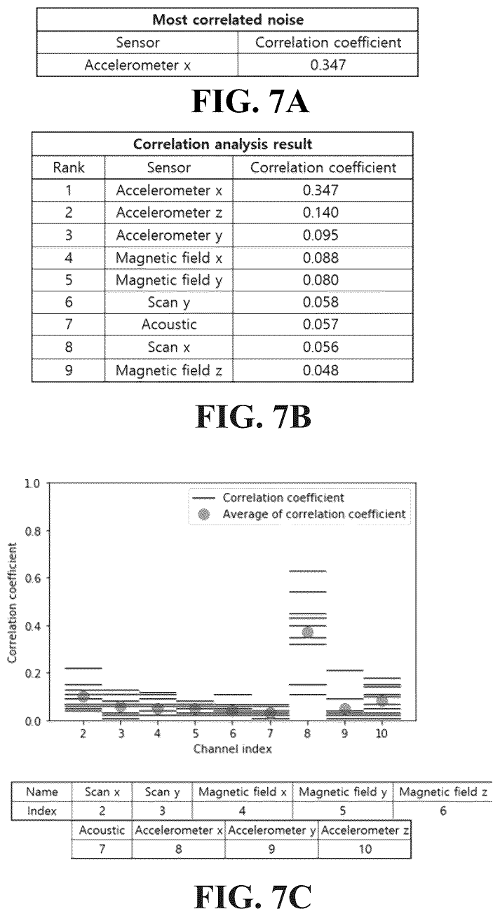

FIGS. 7A, 7B, and 7C are diagrams showing states where correlation coefficients are calculated and displayed to users. In the illustrated experiment, noise sensors include mechanical noise sensors that output noise detection signals Accelerometer X, Accelerometer Y, Accelerometer Z for x, y, z channels, mechanical noise sensors that output noise detection signals Acoustic that detect vibrations in the acoustic frequency band, and magnetic field sensors that output noise detection signals (Magnetic field X, Magnetic field Y, Magnetic field Z) that detect magnetic fields in x, y, z channels. Additionally, the control unit of the microscopy apparatus provided monitor signals Scan X, Scan Y corresponding to X/Y scanning drive signals.

Outputs from photomultipliers (PMT), which are amplification mechanisms of secondary electron detectors, were provided to the processing unit as first detection signals det1. Therefore, a total of 10 channels of signals including 7 channels of noise detection signals, 2 channels of monitor signals, and 1 channel of detection signals were input to the processing unit.

FIG. 7A shows users that noise detected in detection signals has the highest correlation coefficient with mechanical vibrations in the x-axis direction. The embodiment illustrated in FIG. 7B is a diagram exemplifying a state where noise detected in detection signals is sorted in descending order of correlation coefficients. As shown, it can be seen that mechanical vibrations in the x-axis direction have the highest correlation coefficient, followed by mechanical vibrations in the z-axis direction and y-axis direction in order.

FIG. 7C displays correlation coefficients calculated for each channel as lines and displays average values of correlation coefficients as points. As shown, it can be seen that mechanical vibrations in the x-axis input through channel 8 have the highest correlation coefficient values compared to correlation coefficient values of noises input through channels 2 to 7 and channels 9 to 10. From this, users can know that mechanical vibrations in the x-axis provide noise that has the greatest impact on images.

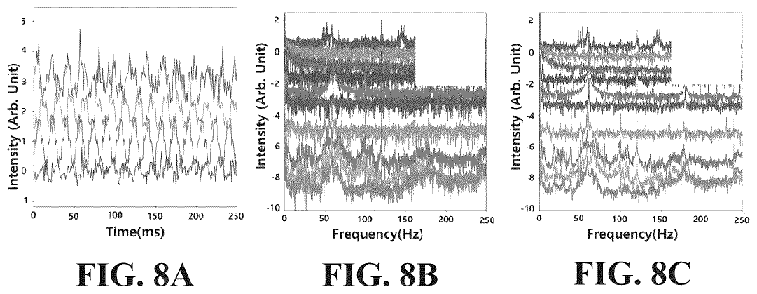

FIG. 8A is a diagram showing input signals in the time domain, FIG. 8B is a diagram showing input signals in the frequency domain, and FIG. 8C is a diagram showing signals displayed in the frequency domain using the Welch method. FIG. 8A is a diagram showing detection signals that are outputs of photomultipliers included in first detectors and signals input through x, y, and z channels by magnetic field sensors detecting magnetic fields in the time domain.

FIG. 8B is a diagram showing signals input through all channels after preprocessing in the frequency domain, and FIG. 8C is a diagram showing signals input through all channels after preprocessing processed by Welch's method in the frequency domain. It can be seen that signal plots that were difficult to distinguish because they were displayed thickly in FIG. 8B are displayed more concisely and clearly by displaying them using Welch's method.

Although the invention has been described with reference to exemplary embodiments illustrated in the drawings to help understand the invention, these are exemplary only, and those skilled in the art will understand that various modifications and equivalent other embodiments are possible from this. Therefore, the true technical protection scope of the invention should be determined by the appended claims.

What is claimed is:

1. An apparatus for evaluating noise effects acting on a microscopy apparatus, the apparatus comprising:
a microscopy apparatus that detects signals generated from a sample to form corresponding detection signals;
a noise sensor unit that detects noise to form corresponding noise detection signals, including a mechanical noise sensor that detects mechanical noise and a magnetic field sensor that detects magnetic field noise;
a control unit that generates monitor signals corresponding to drive signals of the microscopy apparatus; and
a signal processing unit that receives one or more of the noise detection signals and the monitor signals to perform signal processing,
wherein the signal processing unit calculates correlations of one or more of the noise detection signals and the monitor signals on the detection signals.

2. The apparatus of claim 1, wherein the microscopy apparatus is any one of: Scanning Electron Microscope (SEM), Scanning Transmission Electron Microscope (STEM), Scanning Ion Microscope (SIM), Focused Ion Beam (FIB), Helium Ion Microscope (HIM), Scanning Probe Microscope (SPM), Atomic Force Microscope (AFM), and Scanning Tunneling Microscope (STM).

3. The apparatus of claim 1, wherein the mechanical noise sensor includes one or more of: a vibration sensor that detects floor vibrations, a vibration sensor that detects vibrations of the microscopy apparatus, and an acoustic sensor that detects vibrations in a sound frequency band.

4. The apparatus of claim 3, wherein the vibration sensor and the magnetic field sensor are three-axis sensors.

5. The apparatus of claim 1, wherein the microscopy apparatus includes one or more of a scanning unit, stigmator, alignment unit, lens unit, electron source, and high voltage source and current source for driving,
the drive signals of the microscopy apparatus are drive signals of one or more of the scanning unit, stigmator, alignment unit, lens unit, electron source, and high voltage source and current source for driving, and the monitor signals are signals corresponding to the drive signals.

6. The apparatus of claim 1, wherein the microscopy apparatus further includes one or more of a secondary electron detector (SED), backscattered electron detector, transmitted electron detector, specimen absorption current detector, X-ray detector, and electron energy loss spectroscopy detector, and
the detection signals further include signals formed by one or more of the secondary electron detector (SED), backscattered electron detector, transmitted electron detector, specimen absorption current detector, X-ray detector, and electron energy loss spectroscopy detector detecting the sample.

7. The apparatus of claim 1, wherein the signal processing unit calculates correlation coefficients between one or more of the noise detection signals and the monitor signals and the detection signals.

8. The apparatus of claim 7, wherein the correlation coefficients calculated by the signal processing unit are one or more of Pearson correlation coefficient, Spearman correlation coefficient, and distance correlation coefficient.

9. The apparatus of claim 1, wherein the signal processing unit displays the noise, the monitor signals, and the detection signals in one or more of time domain, frequency domain by Welch method, and frequency domain.

10. The apparatus of claim 1, wherein the microscopy apparatus:
positions a probe at any point on the sample and detects signals with a detector, or
positions and scans a probe along any edge of the sample and detects signals, or
positions and scans a probe in a region including at least any portion of the sample and senses and detects signals to form detection signals.

11. The apparatus of claim 1, wherein the processing unit extracts signals within a set frequency band from one or more of the provided noise detection signals and monitor signals and the detection signals, and calculates correlations between the extracted signals and the detection signals.

12. The apparatus of claim 11, wherein the processing unit includes a preprocessing unit comprising:
an FFT calculation unit that performs FFT operations on one or more of the input noise detection signals and monitor signals and the detection signals;
a filter unit that extracts signals within a set band; and
an IFFT calculation unit that performs IFFT (Inverse FFT) operations on output signals from the filter unit.

13. The apparatus of claim 12, wherein the filter unit applies one or more of low-pass filter (LPF), band-pass filter (BPF), and high-pass filter (HPF) to one or more of the provided noise detection signals and monitor signals to extract signals within the set band.

14. The apparatus of claim 11, wherein the set band is a frequency band including frequency bands of noise affecting the microscope images.

15. A method for evaluating noise effects acting on a microscopy apparatus, the method comprising steps of:
detecting secondary electrons, by the microscopy apparatus, formed from the sample to form corresponding detection signals;
detecting noise, by noise sensors including mechanical noise sensors and magnetic field sensors, acting on the microscopy apparatus to form noise detection signals;
generating monitor signals, by a control unit, corresponding to drive signals of the microscopy apparatus; and
calculating correlations, by a signal processing unit, of one or more of the noise detection signals and monitor signals on the detection signals.

16. The method of claim 15, wherein the microscopy apparatus is any one of: Scanning Electron Microscope (SEM), Scanning Transmission Electron Microscope (STEM), Scanning Ion Microscope (SIM), Focused Ion Beam (FIB), Helium Ion Microscope (HIM), Scanning Probe Microscope (SPM), Atomic Force Microscope (AFM), and Scanning Tunneling Microscope (STM).

17. The method of claim 15, wherein the mechanical noise sensor includes: a vibration sensor that detects floor vibrations, a vibration sensor that detects vibrations of the microscopy apparatus, and an acoustic sensor that detects vibrations in a sound frequency band.

18. The method of claim 17, wherein the vibration sensor and the magnetic field sensor are three-axis sensors.

19. The method of claim 15, wherein the microscopy apparatus includes one or more of a scanning unit, astigmatism correction unit, alignment unit, lens unit, electron source, and high voltage source and current source for driving, the drive signals of the microscopy apparatus are drive signals of one or more of the scanning unit, astigmatism correction unit, alignment unit, lens unit, electron source, and high voltage source and current source for driving, and the monitor signals are signals corresponding to the drive signals.

20. The method of claim 15, wherein the microscopy apparatus further includes one or more of a secondary electron detector (SED), backscattered electron detector, transmitted electron detector, specimen absorption current detector, X-ray detector, and electron energy loss spectroscopy detector, and the detection signals further include signals formed by one or more of the secondary electron detector (SED), backscattered electron detector, transmitted electron detector, specimen absorption current detector, X-ray detector, and electron energy loss spectroscopy detector detecting the sample.

21. The method of claim 15, wherein the signal processing unit calculates correlation coefficients between one or more of the noise detection signals and monitor signals and the detection signals.

22. The method of claim 21, wherein the correlation coefficients calculated by the signal processing unit are one or more of Pearson correlation coefficient, Spearman correlation coefficient, and distance correlation coefficient.

23. The method of claim 15, wherein the signal processing unit displays the noise, the monitor signals, and the detection signals in one or more of time domain, frequency domain by Welch method, and frequency domain.

24. The method of claim 15, wherein the microscopy apparatus: positions a probe at any point on the sample and detects signals with a detector, or positions and scans a probe along any edge of the sample and detects signals, or positions and scans a probe in a region including at least any portion of the sample and senses and detects signals to form detection signals.

25. The method of claim 15, further comprising a preprocessing step of extracting signals within a set frequency band from one or more of the provided noise detection signals and monitor signals and the detection signals.

26. The method of claim 25, wherein the preprocessing step includes a preprocessing unit comprising: an FFT calculation step that receives one or more of the noise detection signals and monitor signals and the detection signals and performs FFT operations; a filter step that extracts signals within a set band; and an IFFT calculation step that performs IFFT (Inverse FFT) operations on output signals from the filter unit.

27. The method of claim 26, wherein the filter step is performed by applying one or more of low-pass filter (LPF), band-pass filter (BPF), and high-pass filter (HPF) to one or more of the provided noise detection signals and monitor signals to extract signals within the set band.

28. The method of claim 25, wherein the set band is a frequency band including frequency bands of noise affecting the microscope images.
